(19) United States
(12) Patent Application Publication
(10) Pub. No.: US 2026/0177132 A1
(43) Pub. Date: Jun. 25, 2026

(54) DEVICE FOR MONITORING THE STATE OF DAMAGE OF A POWER TRANSMISSION

(71) Applicant: SAFRAN, PARIS (FR)

(72) Inventors: Amadou ASSOUMANE, MOISSY-CRAMAYEL (FR); Dany ABBOUD, MOISSY-CRAMAYEL (FR); Mohammed EL BADAOUI, MOISSY-CRAMAYEL (FR)

(21) Appl. No.: 19/124,668

(22) PCT Filed: Oct. 25, 2023
(86) PCT No.: PCT/FR2023/051673

§ 371 Date: Apr. 25, 2025

(30) Foreign Application Priority Data
Oct. 26, 2022 (FR) FR2211113

(51) Int. Cl. F16H 3/66; F16H 1/28; F16H 3/54

(52) U.S. Cl. CPC F16H 3/66; F16H 1/28; F16H 1/2836; F16H 3/54; F16H 3/666; F16H 2200/2007

(57) ABSTRACT

A method for monitoring the state of health of a planetary gearset equipping a rotating machine and adapted to perform power transmission on a shaft line of the rotating machine, the method including acquiring a vibratory signal of the rotating machine by a vibration sensor, the vibratory signal including vibrations generated during power transmission by the planetary gearset; constructing a measurement vector and a transition matrix from a phenomenological vibratory model; estimating a possible fault vibratory signature from the measurement vector, the transition matrix and the vibratory signal acquired, the possible fault vibratory signature taking account of a modulation overlap effect; determining a distance by comparing the possible fault vibratory signature with a reference signature.

### TECHNICAL FIELD OF THE INVENTION

The technical field of the invention is that of monitoring the state of health of mechanical components used in power transmission.

This invention relates to a method and a device for monitoring the state of health of a planetary gearset.

### TECHNOLOGICAL BACKGROUND OF THE INVENTION

Shaft lines integrated into rotating machines, for example an aircraft engine, are conventionally equipped with different mechanical parts or components, such as bearings and gears. Amongst this equipment, planetary gearsets, also referred to as planetary reduction gears, are mechanical parts including several concomitant gears. An example of a planetary gearset including 4 planetary gears 13 and a sun gear 14 is provided in FIG. 1.

Operating a planetary gearset generates complex vibratory signals subject to modulation overlap. Monitoring the state of health of such a component to detect excessive and premature degradation is therefore not easy to implement.

Nevertheless, it is essential to ensure proper mechanical strength and life time of the shaft line equipped with it, in order to avoid malfunctions in the systems into which they are integrated.

The modulation phenomenon is already known for gears with parallel axes. This phenomenon is related to the amplitude and/or phase modulation of the fault frequency by the meshing frequency. In the case of a planetary gearset, the modulation is much more complex due to the presence of several elements within the same gearset. For example, upon rotating the planet carrier, holding the ring gear stationary, there will be a modulation in the rotation frequency of the sun gear and in the rotation frequency of the planet gears by the rotation frequency of the planet carrier. This modulation is even more complex when the gearset includes several planet gears. This is referred to as multi-modulation planetary gearset.

By “modulation overlap”, it is meant the phenomenon whereby a frequency of a fault on a gear appears, in the spectrum of the vibratory signal associated therewith, at an erroneous location due to the fact that the modulation frequency of the gear is higher than the frequency of the fault. An analogy of this phenomenon can be done in optics: when an observer looks with the naked eye at a vehicle wheel whose rotation frequency is higher than the eye's sampling frequency, the observer has the impression that the wheel is rotating in the opposite direction of rotation. This phenomenon is particular to planetary gearsets, for which there is always a modulation frequency greater than the fault frequency, in comparison with gears with parallel axes. Furthermore, the multiple modulation sources for a planetary gearset generate a much more complex overlap than can occur with a gear with parallel axes.

Approaches for monitoring gears based on the estimation of amplitude and/or phase modulations of the meshing vibration, which are signatures revealing the state of health of the gears, are known from the state of the art (P. D. McFadden, ‘Detecting fatigue cracks in gears by amplitude and phase demodulation of the meshing vibration’, 1986; U.S. Pat. No. 6,526,356B1; U.S. Pat. No. 6,898,975B2; EP2434266A2; U.S. Pat. No. 9,797,808B2; U.S. Pat. No. 8,963,733B2). These techniques focus on estimating the modulations around the meshing or its harmonics and are relevant in the event of non-overlap of the modulations between each other and for a shaft operating in a steady state operating condition. However, they are not adapted to the case of planetary gearsets whose vibratory signals are subject to spectral aliasing, generating modulation overlap. In particular, these approaches take account neither of the interactions between the natural modulations of the gear and the modulations related to its damage, nor of the masking of gear modulations by noise. Indeed, in the vibratory signals of a planetary gearset there are not only specific frequencies related to damage to the gear but also frequencies modulating meshing, for example: the rotation frequencies of the planet carrier, frequencies of a fault, interaction between the fault and the variation in position of the fault relative to the fixed sensor, etc. Additionally, these approaches are not adapted to the case where the operating condition of one of the connected shafts of the planetary gearset is non-steady state, which is however the case in aeronautical applications.

There is therefore a need for a means of monitoring a planetary gearset which is robust to modulation overlap under steady state and non-steady state operating conditions of the rotating machine.

### SUMMARY OF THE INVENTION

The invention offers a solution to the problems discussed previously, by making it possible to monitor the state of health of planetary gearsets equipping a high-power transmission system, for example a rotating machine.

A first aspect of the invention relates to a method for monitoring the state of health of a planetary gearset equipping a rotating machine and adapted to perform power transmission on a shaft line of said rotating machine, the method comprising the following steps of:
Acquiring a vibratory signal of the rotating machine by a vibration sensor, the vibratory signal including vibrations generated during power transmission by the planetary gearset;
Constructing a measurement vector and a transition matrix from a phenomenological vibratory model, this model being based on a Fourier series decomposition of the vibratory signal taking account of interactions of different vibratory sources of the planetary gearset;
Estimating a possible fault vibratory signature from the measurement vector, the transition matrix and the vibratory signal acquired, the possible fault vibratory signature taking account of a modulation overlap effect;
Determining a distance by comparing the possible fault vibratory signature with a reference signature.

By virtue of the invention, it is possible to reliably and robustly determine the presence of a fault in one or more elements of the planetary gearset. Indeed, by virtue of the phenomenological modelling of the gear vibratory signal and the recursive estimation of parameters of the model constructed, it is possible to estimate the different modulation components bearing information on the state of health of a gear, as well as their mutual interaction. Modulations are thus estimated using a deterministic approach by virtue of the phenomenological vibratory model and a priori knowledge of the kinematics of the power transmission, contained in the measurement vector and the transition matrix. In addition, the modelling takes account of interactions between modulations generated by the power transmission within the planetary gearset, originating from the various vibratory sources that are the different elements of the planetary gearset (planet gears, planet carrier, sun gear and ring gear), making the approach robust to modulation overlap.

Advantageously, the solution provided is valid for both steady state and non-steady state condition of the rotating machine. Furthermore, by taking account of the different modulation sources, it is robust to noise and peaks unrelated to power transmission.

Additionally, as the method is usable in real time, it can serve to monitor the progression of damage, for example the propagation of a crack from a tooth through the gear.

Further to the characteristics just discussed in the preceding paragraph, the method according to the first aspect of the invention may have one or more additional characteristics from among the following, considered individually or according to any technically possible combination.

In one embodiment, the vibratory signal is acquired during an acquisition duration, the acquisition duration being at least as long as a duration corresponding to a predetermined number of rotation cycles of a shaft of the rotating machine connected to the planetary gearset.

By virtue of this embodiment, it is possible to monitor the planetary gearset in real time by successive repeated implementations of the method according to the first aspect of the invention.

In one embodiment, in the acquisition step a speed of rotation of the shaft of the rotating machine connected to the planetary gearset is also measured.

By virtue of this embodiment, it is possible to have a reference speed for constructing the phenomenological vibratory model.

In one embodiment, the measurement vector is constructed from kinematics data of the planetary gearset and of the shaft to which the planetary gearset is connected, and from parameters of the phenomenological vibratory model.

In one embodiment, the transition matrix is an identity matrix whose size depends on the parameters of the phenomenological vibratory model.

In one embodiment, the step of estimating the possible fault vibratory signature comprises the following two sub-steps of:
Recursively estimating an estimated vector of the parameters of the model of the signal acquired, the estimation being a recursive estimation performed by means of a Kalman filter, the Kalman filter taking as an input the vibratory signal acquired, the transition matrix and the measurement vector;
Reconstructing the possible fault vibratory signature from the estimated vector of parameters of the model of the signal acquired.

In one embodiment, the distance is a difference between a standard deviation of a possible fault indicator calculated for the possible fault vibratory signature and a standard deviation of the possible fault indicator calculated for the reference signature.

A second aspect of the invention relates to a device for monitoring the state of health of a planetary gearset, the device comprising:
An acquisition module comprising at least the vibration sensor and configured to implement the acquisition step of the method;
A processing module configured to implement the steps of constructing a measurement vector and a transition matrix, estimating a possible fault vibratory signature, determining a distance and issuing an alert.

This second aspect according to the invention makes it easy to implement the method according to the first aspect by means of a simple device.

A third aspect of the invention relates to a computer program product comprising instructions which, when the program is executed on a computer, cause the same to implement the steps of the method according to the first aspect.

A fourth aspect of the invention relates to a computer-readable medium comprising instructions which, when executed by a computer, cause the same to implement the steps of the method according to the first aspect.

The invention and its different applications will be better understood upon reading the following description and upon examining the accompanying figures.

### BRIEF DESCRIPTION OF THE FIGURES

The figures are set forth by way of indicating and in no way limiting purposes of the invention.

FIG. 1 is an illustration of a planetary gearset.

FIG. 2 is an overview diagram illustrating the sequence of steps of a method according to the invention.

FIG. 3 is a vibratory signal from the planetary gearset acquired during the execution of the method.

FIG. 4 is a spectrum of the vibratory signal acquired.

FIG. 5 is a spectrum of an estimation around the fundamental meshing.

FIG. 6 is a spectrum of the signature of a sun gear without taking account of the modulation effect by a planet carrier.

FIG. 7 is the spectrum of the estimated signature of the sun gear with a meshing effect and a modulation effect of the harmonic 1 of the planet carrier.

FIG. 8 shows the signature spectrum with taking account of the effect of modulating the harmonic 4 of the planet carrier.

FIG. 9 is a graph representing a course of a possible fault indicator.

### DETAILED DESCRIPTION

Unless otherwise specified, a same element appearing in different figures has a single reference.

A first aspect of the invention relates to a method for monitoring the state of health of a planetary gearset equipping a rotating machine. The planetary gearset is adapted to perform power transmission on a shaft line of said rotating machine.

By “rotating machine”, it is meant a motor which transforms energy supplied thereto into a rotary movement, for example through a shaft line. In the context of the invention, this applies especially to aircraft such as aeroplanes or helicopters, but it can also apply to wind turbine motors, vehicle motors or engines, etc.

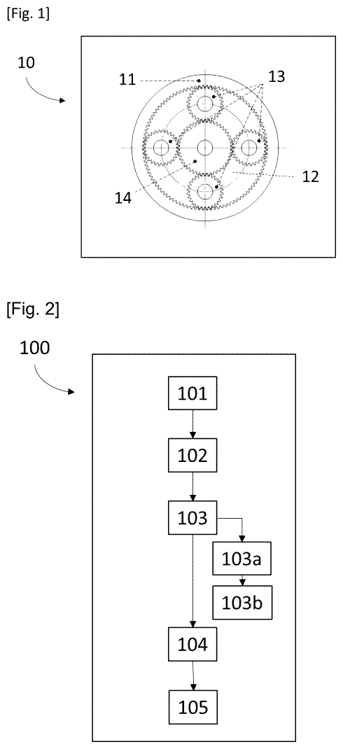

FIG. 1 is a schematic representation of the planetary gearset 10. This comprises several elements: a ring gear 11, a planet carrier 12, four planet gears 13 and a sun gear 14. Each element of the planetary gearset 10 is connected to one of the shafts of the rotating machine.

Loading the planetary gearset 10 by rotating one of its elements generates vibrations from each of the elements and possible faults. These vibrations can be sensed by a vibration sensor which will produce a vibratory signal comprising the vibrations produced by each of the aforementioned sources as well as noise. This may be noise from other members of the rotating machine or noise related to the environment of said machine.

By “fault”, it is meant a discontinuity in the properties of the material making up a part or object inspected, herein the planetary gearset 10. This discontinuity results from a malfunction in the material. This malfunction can have various origins and be of a varied nature. These malfunctions are predominantly the consequence of hazards that occur during the manufacture of the part. These malfunctions also occur quite frequently during the use or handling of the part: the material may, for example, have been embrittled during the manufacturing process and its use, generating high local stresses at the embrittled zone, or following an impact, causes a fault. The term “fault” therefore covers all the forms of malfunction that the material may undergo: material fault, inclusion, crack, porosity, corrosion, impairment of the material properties, etc.

In particular, the case of a gear teeth fault is considered herein.

In general terms, let us consider that the planetary gearset 10 comprises Nₚ planet gears 13 with Zₚ teeth, the planet carrier 12, the sun gear 14 with Zₛ teeth and the ring gear 11 with Z_{c} teeth. The angular velocity of the planet carrier 12, the angular velocity of the sun gear 14, the angular velocity of the ring gear 11 and the angular velocity of one of the planet gears 13 are respectively noted ωₚₚ, ωₛ, ω_{c} and ωₚ.

In a similar way, the angular velocities of a fault on the planet carrier 12, on the sun gear 14, on the ring gear 11 and on one of the planet gears 13 are respectively noted

$${ω}_{pp}^{( d )} , {ω}_{s}^{( d )} , {ω}_{c}^{( d )} and {ω}_{p}^{( d )} .$$

By way of generalization, ω_{fault} is the angular velocity of the fault regardless of the element on which it is located.

It is considered that the vibratory signal of the planetary gearset 10 comprises two components:
A natural component related to the engagement of the teeth of the planet gears with those of the ring gear or between those of the sun gear;
An anomalous component related to the presence of a fault in one of the elements.

The amplitude associated with each of the components is modulated by the movability of the gear members. The amplitude of each component in the vibratory signal is therefore more or less strong as a function of the relative position of the point of contact between the teeth, which are movable, and the sensor, which is fixed.

Explicitly, the meshing signal s in the presence of the fault can be modelled by means of a phenomenological model, in discrete time, in the form of

$$s [ t ] = {\sum }_{k = - K , k \neq 0}^{K} {\sum }_{i = 1}^{{N}_{p}} ( 1 + {w}_{i} [ t ] ) ( 1 + {s}_{i , fault} [ t ] ) {s}_{k , i , mesh} [ t ] + n [ t ] , \qquad [ Math . 1 ]$$

where:
K is a number of meshing harmonics, defined by an operator as a function of the desired model accuracy,
wᵢ is a weighting function resulting from the position of the contact point of the i-th planet relative to the position of the fixed sensor,
s_{i,fault} is the signal generated by the fault in contact with the i-th planet,
s_{k,i,mesh} is the k-th meshing harmonic generated by the i-th planet,
n is a measurement noise, characterised by a variance r and containing sensor noise, structure-borne noise and non-modelled vibration components,
And t is the discrete time index or the signal sample index.

Four load configurations for the planetary gearset 10 are to be considered:
Configuration 1: the ring gear is fixed and the other gear members are movable; in this case, the weighting function wᵢ is non-zero.
Configuration 2: the planet carrier is fixed and the other gear members are movable with the planet gears rotating about their axis; in this case, the weighting function wᵢ is zero.
Configuration 3: the sun gear is fixed and the other gear members are movable; in this case, the weighting function wᵢ is non-zero.
Configuration 4: all the gear members are movable; in this case, the weighting function wᵢ is non-zero.

In the following, only configurations 1, 3 and 4, where the weighting function is non-zero, are considered. In the second configuration, the weighting function wᵢ is zero and the planetary gearset 10 is processed as a gear with parallel axes.

In configurations 1, 3 and 4, the weighting function is considered to be periodic at the period of rotation of the planet carrier

$${T}_{pp} = \frac{2 π}{{ω}_{pp}} .$$

Consequently, the function wᵢ can be approximated by a trigonometric series with variable coefficients such as

$${w}_{i} [ t ] = {\sum }_{q = - Q , q \neq 0}^{Q} {β}_{q , i} [ t ] {e}^{jq {ω}_{pp} ( ( t - 1 ) {t}_{s} + {t}_{i} )} , \qquad [ Math . 2 ]$$

with:
Q the number of harmonics contained in the weighting function wᵢ, defined by the operator as a function of the desired model accuracy,
β_{q,i} an amplitude of the weighting function for the q-th harmonic of the i-th planet gear,
tₛ the sampling period inverse of the sampling frequency fₛ,
tᵢ a time offset between the vibration of the i-th planet gear and that of the (i−1)-th planet gear and is equal to tᵢ=ψᵢ/ωₚₚ with ψᵢ the angular phase shift between two consecutive planet gears.

In vector form, the weighting function is written as

$${w}_{i} [ t ] = {h}_{{w}_{i}}^{T} [ t ] {β}_{i} [ t ] , \qquad [ Math . 3 ]$$

$$with :$$

$${h}_{{w}_{i}} [ t ] = {( {e}^{- j Q {ω}_{p p} ( ( t - 1 ) {t}_{s} + {t}_{i} )} … {e}^{jQ {ω}_{p p} ( ( t - 1 ) {t}_{s} + {t}_{i} )} )}^{T} ∈ {ℂ}^{2 Q \times 1} , \qquad [ Math . 3 a ]$$

$$And$$

$${β}_{i} [ t ] = {( {β}_{- Q , i} [ t ] … {β}_{Q , i} [ t ] )}^{T} ∈ {ℂ}^{2 Q \times 1} . \qquad [ Math . 3 b ]$$

Since the meshing between the teeth is periodic at the meshing period, the k-th meshing harmonic of the i-th planet gear is written as follows

$$\begin{matrix}{s}_{k , i , mesh} [ t ] = {α}_{k , i} [ t ] {e}^{j k {Z}_{c} {ω}_{pp} ( ( t - 1 ) {t}_{s} + {t}_{i} )} \\ = {h}_{k , i , mesh} [ t ] {α}_{k , i} [ t ]\end{matrix} , \qquad [ Math . 4 ]$$

with:
α_{k,i} the complex envelope of the meshing under consideration; this envelope contains the amplitude and phase of the meshing.

For a fault on the planetary gearset 10, the characteristic signal of the fault is periodic at the fault period

$${T}_{fault} = \frac{2 π}{{ω}_{fault}} ,$$

where ω_{fault} Is the angular velocity of the fault. As previously, this signal can be expressed as a trigonometric series such that

$$\begin{matrix}{s}_{i , fault} [ t ] = {\sum }_{m = - M , m \neq 0}^{M} {ρ}_{m , i} [ t ] {e}^{jm {ω}_{fault} ( ( t - 1 ) {t}_{s} + {t}_{i} )} \\ = {h}_{{s}_{i , fault}}^{T} [ t ] {ρ}_{i} [ t ]\end{matrix} , \qquad [ Math . 5 ]$$

$$with :$$

$$[ Math . 5 a ]$$

$${h}_{{s}_{i , fault}} [ t ] = ( {e}^{- jM {ω}_{fault} ( ( t - 1 ) {t}_{s} + {t}_{i} )} … {e}^{{jM {ω}_{fault} ( ( t - 1 ) {t}_{s} + {t}_{i} ) )}^{T}} ∈ {ℂ}^{2 M \times 1} ,$$

$${ρ}_{i} [ t ] = {( {ρ}_{- M , i} … {ρ}_{M , i} )}^{T} ∈ {ℂ}^{2 M \times 1} \qquad [ Math . 5 b ]$$

And M is the number of harmonics of the characteristic signal of the fault, defined by the operator as a function of the desired model accuracy.

The vibratory signal in equation [Math. 1] can then be rewritten as

$$s [ t ] = {\sum }_{k = - K , k \neq 0}^{K} {\sum }_{i = 1}^{{N}_{p}} ( 1 + {h}_{{w}_{i}}^{T} [ t ] {β}_{i} [ t ] + {h}_{{s}_{i , fault}}^{T} [ t ] {ρ}_{i} [ t ] + {h}_{{w}_{i}}^{T} [ t ] {β}_{i} [ t ] {h}_{{s}_{i , fault}}^{T} [ t ] {ρ}_{i} [ t ] ) {h}_{k , i , mesh} [ t ] {α}_{k , i} [ t ] + n [ t ] \qquad [ Math . 6 ]$$

In vector form, this signal is written as

$$s [ t ] = {\sum }_{k = - K , k \neq 0}^{K} {\sum }_{i = 1}^{{N}_{p}} {h}_{k , i}^{T} [ t ] {x}_{k , i} [ t ] + n [ t ] \qquad [ Math . 7 ]$$

$$where :$$

$${h}_{k , i} [ t ] = {h}_{k , i , mesh} [ t ] ( {\begin{matrix}1 & {h}_{{w}_{i}}^{T} [ t ] & {h}_{{s}_{i , fault}}^{T} [ t ] & {h}_{{w}_{i}}^{T} [ t ] ⊗ {h}_{{s}_{i , fault}}^{T} [ t ] )\end{matrix}}^{T} ∈ {ℂ}^{1 + 2 ( M + Q ) + 4 MQ \times 1} \qquad [ Math . 7 a ]$$

$$and$$

$${x}_{k , i} ( t ) = ( {\begin{matrix}{α}_{k , i} [ t ] & {β}_{i} [ t ] {α}_{k , i} [ t ] & {ρ}_{i} [ t ] {α}_{k , i} [ t ] & {β}_{i} [ t ] ⊗ {ρ}_{i} [ t ] {α}_{k , i} [ t ] )\end{matrix}}^{T} ∈ {ℂ}^{1 + 2 ( M + Q ) + 4 MQ \times 1} . \qquad [ Math . 7 b ]$$

Likewise, equation [Math. 7] is reduced such that

$$s [ t ] = {\sum }_{k = - K , k \neq 0}^{K} {h}_{k}^{T} [ t ] {x}_{k} [ t ] + n [ t ] , \qquad [ Math . 8 ]$$

$$where :$$

$${h}_{k}^{T} [ t ] = {( {h}_{k , 1}^{T} [ t ] … {h}_{k {N}_{p}}^{T} [ t ] )}^{T} ∈ {ℂ}^{{N}_{p} ( 1 + 2 ( M + Q ) + 4 MQ ) \times 1} , \qquad [ Math . 8 a ]$$

$$and$$

$${x}_{k} [ t ] = {( {x}_{k , 1}^{T} [ t ] … {x}_{k {N}_{p}}^{T} [ t ] )}^{T} ∈ {ℂ}^{{N}_{p} ( 1 + 2 ( M + Q ) + 4 MQ ) \times 1} \qquad [ Math . 8 b ]$$

In compact form, the vibratory signal s can thus be written as follows

$$s [ t ] = {h}^{T} [ t ] x [ t ] + n [ t ] , \qquad [ Math . 9 ]$$

$$with :$$

$$h [ t ] = {( {h}_{- K}^{T} [ t ] … {h}_{K}^{T} [ t ] )}^{T} ∈ {ℂ}^{2 {KN}_{p} ( 1 + 2 ( M + Q ) + 4 MQ ) \times 1} \qquad [ Math . 9 a ]$$

the measurement vector

$$x [ t ] = {( {x}_{- K}^{T} [ t ] … {x}_{K}^{T} [ t ] )}^{T} ∈ {ℂ}^{2 {KN}_{p} ( 1 + 2 ( M + Q ) + 4 MQ ) \times 1} \qquad [ Math . 9 b ]$$

the vector of model parameters.

The model parameter vector x implicitly contains information relating to the state of health of the gear members.

Given the slow variation in the parameters of the vector x, it is possible to apply a smoothing restriction to the vector of model parameters. The smoothing restriction is of an order greater than or equal to 1. Preferably, the smoothing restriction is of order 1, and its explicit expression is

$$x [ t + 1 ] = x [ t ] + b [ t ] , \qquad [ Math . 10 ]$$

with
b a Gaussian white noise vector with covariance matrix C; the size of the white noise vector is the same as that of the model parameter vector.

In this case, the transition matrix F is the identity matrix of the size 2KNₚ(1+2(M+Q)+4MQ)×2KNₚ(1+2(M+Q)+4MQ).

Alternatively, the size of the transition matrix F can be different if the order of the smoothing restriction is greater than 1. For example, for a smoothing restriction of order 2, equation [Math. 10] becomes x[t+1]=2x[t]−x[t−1]+b[t] and the transition matrix F is written as

$$F = [ \begin{matrix}0 & 1 \\ - 1 & 2\end{matrix} ] .$$

Equations [Math. 9] and [Math. 10] represent the measurement equation and the equation of state for the vibratory signal s respectively.

Advantageously, the above phenomenological model can be applied to planetary gearsets as well as to gears with parallel axes, which are explicitly integrated into this vibratory model.

From what precedes, the aim of the present invention is to produce an estimation of the vector of parameters of the model of the signal acquired, noted x, from the construction of the transition matrix F of said signal and a determination of the measurement vector h. The aim is then to extract one or more vibratory signatures of a possible fault and then to compare and analyse these vibratory signatures with one or more reference signatures S_{ref} in order to detect the presence of one or more possible faults on one or more elements of the planetary gearset 10.

Method 100 for monitoring the state of health of a planetary gearset is depicted in FIG. 2. Method 100 comprises five steps numbered 101 to 105.

The first step 101 is a step of acquiring the vibratory signal s by means of a vibration sensor.

The vibration sensor is, for example, a displacement sensor, a speed sensor or an accelerometer. Preferably, the vibration sensor is an accelerometer based on piezoelectric technology.

The vibratory signal is acquired at the sampling frequency fₛ. Preferably, the sampling frequency is at least twice as high as the maximum number of meshing harmonics considered for the planetary gearset.

The acquisition duration of the vibratory signal is at least as long as a duration corresponding to a predetermined number of rotation cycles of a shaft of the rotating machine connected to the planetary gearset 10. The predetermined number of rotation cycles of the shaft is greater than 1 and may be an integer or real number. Preferably, the predetermined number of cycles of rotation of the shaft is selected so as to cover sufficient cycles of rotation to guarantee robust and reliable analysis of the signal and to limit the size of the signal, thus enabling rapid analysis of said signal and real-time monitoring of the planetary gearset 10. The acquisition time is therefore advantageously short to enable the implementation of method 100 to be repeated at a real time rate.

The acquisition duration is at least as long as the duration corresponding to the predetermined number of rotation cycles of the shaft connected to the planetary gearset 10 which has the slowest speed of rotation.

The signal duration can additionally be set by a maximum number of samples T to be acquired at the sampling frequency fₛ.

The vibration sensor is placed on or in proximity to the rotating machine. Preferably, the vibration sensor is placed in proximity to the shaft connected to the planetary gearset 10, for example on a framework of said shaft.

The acquisition step 101 may also relate to the measurement of a speed of rotation of the shaft connected to the planetary gearset 10. The speed of rotation is especially noted ω₀.

The speed of rotation of the shaft can be obtained directly by means of a speed sensor, for example a tachometer.

It is also possible to use another type of speed sensor, providing a square-wave, sinusoidal or pulse series speed signal. This speed signal is then processed to estimate the speed of rotation of the shaft. This processing can be carried out by:
Detection of instants of rising edges of the square-wave speed signal;
Estimation of the instantaneous frequency of the sinusoidal speed signal;
Temporal pulse localisation.

Preferably, the speed of rotation of the shaft is simultaneously measured with the vibratory signal, throughout the acquisition duration.

Alternatively, the speed of rotation can be determined from the operating condition of the rotating machine, for which the speeds of rotation of the different shafts as a function of its operating condition are known.

The second step 102 is a step of constructing the measurement vector h and the transition matrix F. The purpose of constructing the measurement vector h is to model the frequency location of the frequencies of interest, especially the meshing frequency, the gear frequencies and those of a possible fault. The purpose of constructing the transition matrix F is to describe the type of variation in the amplitude of damage signatures or modulation amplitudes, in particular to specify whether this variation is fast or slow over time.

The transition matrix F is constructed as a function of the smoothing restriction selected for the model. herein, for a smoothing restriction of order 1, the transition matrix F is the identity matrix of the size 2KNₚ(1+2(M+Q)+4MQ)×2KNₚ(1+2(M+Q)+4MQ), as described above.

The measurement vector h is constructed from known data about the kinematics of the shaft and the planetary gearset 10, according to equations Math. 1 to 9. Herein, the measurement vector h is constructed from:
the number Q of harmonics contained in the weighting function, wᵢ the number M of harmonics of the fault characteristic signal,
the number K of meshing harmonics,
the angular velocity of the fault ω_{fault},
the sampling period tₛ
the time offset tᵢ between the vibration of the i-th planet gear and that of the (i−1)-th planet gear,
the weighting function wᵢ,
the rotation frequencies of the ring gear, the sun gear, the planet gears and the planet carrier f_{c}, fₛ, fₚ, and fₚₚ respectively.

The rotation frequencies of the ring gear, the sun gear, the planet gears and the planet carrier, resulting from the kinematics of the planetary gearset, are known, for example, upon reading Table 1 hereinafter.

TABLE 1

| Condition | fᵢₙₚᵤₜ | fₒᵤₜₚᵤₜ | fₚ | f_{eng} | ${f}_{s}^{( d )}$ | ${f}_{c}^{( d )}$ | ${f}_{p}^{( d )}$ |
|---|---|---|---|---|---|---|---|
| f_{c} = 0 | fₛ | ${f}_{pp} = \frac{{Z}_{s}}{{Z}_{s} + {Z}_{c}} {f}_{s}$ | $- \frac{{Z}_{s} ( {Z}_{c} - {Z}_{p} )}{{Z}_{p} ( {Z}_{s} + {Z}_{c} )}$ | Zₛfₛ | fₛ or Nₚfₛ | Nₚfₚₚ Nₚf_{c} | 10 2fₚ |
| fₚₚ = 0 | | ${f}_{c} = - \frac{{Z}_{s}}{{Z}_{c}} {f}_{s}$ | $- \frac{{Z}_{s}}{{Z}_{p}} {f}_{s}$ | | | | |
| fₛ = 0 | f_{c} | ${f}_{pp} = \frac{{Z}_{c}}{{Z}_{s} + {Z}_{c}} {f}_{c}$ | $\frac{{Z}_{c} ( {Z}_{s} + {Z}_{p} )}{{Z}_{p} ( {Z}_{s} + {Z}_{c} )} {f}_{c}$ | Z_{c}f_{c} | Nₚfₚₚ | Nₚfₚₚ | |

It is to be noted that the angular velocity of the fault ω_{fault} depends on the element on which it is located, such as

$${ω}_{fault} = 2 π {f}_{z}^{( d )} , with {f}_{z}^{( d )}$$

the frequency of the fault on the element z∈{s, c, p}.

The input frequency fᵢₙₚᵤₜ of the planetary gearset 10 is determined from the speed of rotation of the shaft ω₀ or is estimated from the vibratory signal.

Step 103 is then a step of estimating the possible fault vibratory signature(s). The fault may correspond to a fault in the gear teeth of one of the elements of the planetary gearset 10. The step 103 of estimating possible fault vibratory signature(s) comprises two sub-steps 103a and 103b.

Sub-step 103a is a step of estimating the estimated vector \hat{x} of the model parameters of the signal acquired. The estimation is preferably performed recursively by means of a Kalman filter, according to the Rauch-Tung-Striebel alternative, for example. The advantage of using such a Kalman filter is to benefit from its recursivity and its applicability in real time. Alternatively, it is possible to use other robust estimators such as an LMS (Least Mean-Squares) filter or a synthesis H_{∞}.

As an input, the Kalman filter uses the transition matrix F, the measurement vector h and the signal acquired s.

As an output, the Kalman filter provides the estimate x of the vector of the model parameters of the signal acquired.

The Kalman filter uses as parameters the initialisation of the estimated vector \hat{x}[1], a covariance matrix P[1] of an initialisation error, the covariance C of the state noise and the variance r of the measurement noise.

The purpose of using such an estimator is that it can filter out the noise and smooth the estimation in the event of an error during the filtering phase.

Next, sub-step 103b is a step of reconstructing the possible fault vibratory signature(s) Ŝ. The reconstruction is carried out by means of the preceding equations [Math. 1 to 9] and from the estimate \hat{x} of the vector of the model parameters of the signal acquired.

Each possible fault vibratory signature Ŝ is a matrix constructed as Ŝ=[ŵ, ŝ_{fault}, ŝ_{k,mesh}, ŝ_{interaction}], with

$$\hat{w} = {( {\sum }_{i} {\hat{w}}_{i} [ t = 1 ] … {\sum }_{i} {\hat{w}}_{i} [ t = T ] )}^{T} ,$$

$${\hat{s}}_{fault} = {( {\sum }_{i} {\hat{s}}_{i , fault} [ t = 1 ] … {\sum }_{i} {\hat{s}}_{i , fault} [ t = T ] )}^{T} ,$$

$${\hat{s}}_{k , mesh} = {( {\sum }_{i} {\hat{s}}_{k , i , mesh} [ t = 1 ] … {\sum }_{i} {\hat{s}}_{k , mesh} [ t = T ] )}^{T} ,$$

$$and {\hat{s}}_{i n t e r a c t i o n} = ( 1 + w ) {\hat{s}}_{fault} .$$

The vectors ŵ, ŝ_{fault}, ŝ_{k,mesh} et ŝ_{interaction} are of the sizes T or have a number of samples equal to T. The vector ŝ_{fault} expresses the estimation of the possible fault vibratory signature. The vector ŝ_{interaction} expresses the interaction between the fault and the weighting function due to the fixed position of the sensor relative to the variable position of each planet gear.

The vector ŵ can be reconstructed as follows: for each sample t, set to zero all the elements in the measurement vector h except those corresponding to the vector h_{w}_{ᵢ}.

The vectors ŝ_{fault}, ŝ_{k,mesh} et ŝ_{interaction} can be reconstructed in the same way as for the vector ŵ.

Step 104 is then a step of comparing the possible fault vibratory signature(s) Ŝ with the reference signature S_{ref}.

If no reference signature S_{ref} is available, then the or at least one of the possible fault vibratory signatures Ŝ becomes the reference signature(s) S_{ref}. Preferably, the possible fault vibratory signature Ŝ is that of a healthy planetary gearset, i.e. without any fault.

The comparison provides a distance between each of the possible fault vibratory signatures Ŝ and the reference signature S_{ref}. The distance is determined as a difference between a standard deviation of a possible fault indicator and a standard deviation of a reference indicator.

The possible fault indicator and the reference indicator are of the same nature, i.e. they are obtained from a same mathematical formula. In particular, the indicators may be energy indicators, for example an RMS value of the signature, and/or a statistical indicator, for example a kurtosis.

By way of example, the RMS value of the signature ŝ_{fault} is

$${V}_{eff} = {\sum }_{t = 1}^{t = T} {\hat{s}}_{fault}^{2} ( t )$$

given that ŝ_{fault}(t)=Σᵢ ŝ_{i,fault}[t]. In this case, the distance is the difference between the standard deviation of the RMS value of the possible fault vibratory signature Ŝ and the standard deviation of the RMS value of the reference signature S_{ref}.

Finally, step 105 is a step of issuing an alert as a function of the distance calculated in the preceding step.

The alert is triggered when the absolute value of the distance is greater than or equal to an alert threshold. This alert threshold can be an integer or real multiple of the standard deviation of the reference indicator. For example, this threshold is equal to three times the absolute value of the standard deviation of the reference indicator.

Furthermore, an alarm can be triggered when the distance exceeds an alarm threshold. This alarm threshold can be an integer or real multiple of the standard deviation of the reference indicator. For example, this threshold is equal to six times the absolute value of the standard deviation of the reference indicator.

The alert and/or alarm informs the operator of the state of the rotating machine, in particular that a fault has been detected on one of the planetary gearset elements 10. On the basis of this alert and/or the alarm, the operator can decide to initiate a maintenance operation in order to correct the detected fault. The alert informs of damage that is not too severe and does not require the machine to be stopped, while the alarm informs of severe damage requiring the machine to be stopped.

Once the alert and/or alarm has been issued, it is possible to repeat the execution of method 100 to acquire a new vibratory signal, according to step 101, and perform analysis of said new signal according to steps 102 to 105.

In the case where no alert or alarm is issued, it is also possible to repeat execution of method 100 to acquire the new vibratory signal, according to step 101, and perform analysis of said new signal according to steps 102 to 105.

In one alternative, the monitoring is translated into graphical form. In this case, the course of the different indicators is displayed, as well as the alert and/or alarm thresholds, throughout the monitoring, by repeatedly executing method 100.

A second aspect according to the invention relates to a device for monitoring the state of health of the planetary gearset 10. The device comprises software and hardware means for implementing method 100.

In particular, the monitoring device comprises an acquisition module comprising the vibration sensor, a signal conditioner, an analogue-to-digital converter, a volatile and/or non-volatile memory and a processor. Instructions are included in the memory of the acquisition module which, when executed by the processor, enable the implementation of the acquisition step 101 of the method 100, for the acquisition of the vibratory signal and, if necessary, of the speed of rotation of the shaft connected to the planetary gearset 10.

The monitoring device also includes a processing module, comprising a processor and a volatile or non-volatile memory. The memory of the processing device includes instructions which, when executed by the processor, enable steps 102 to 105 of method 100 to be implemented. The processing module may also include display means, such as a screen and a graphical user interface, for translating the monitoring into graphical form.

The acquisition module and the processing module can be implemented in two different devices.

Two examples are provided hereinafter to demonstrate the performance and usefulness of method 100. The first example relates to the monitoring of a planetary gearset on a measurement bench. The second example is concerned with monitoring the progression of damage.

In the first example, the ring gear 11 has Z_{c}=96 teeth and is fixed. The gear input is the sun gear 14 with Zₛ=34 teeth and the output is the planet carrier 12 with Nₚ=5 planet gears 13 having Zₚ=31 teeth. The vibratory signal is acquired at a sampling frequency of fₛ=51.2 kHz. On this test bench, seizure was noticed on sun gear 14. Method 100 is therefore applied to extract the signature of the fault on sun gear 14, the period of which is equal to the period of rotation of sun gear 14.

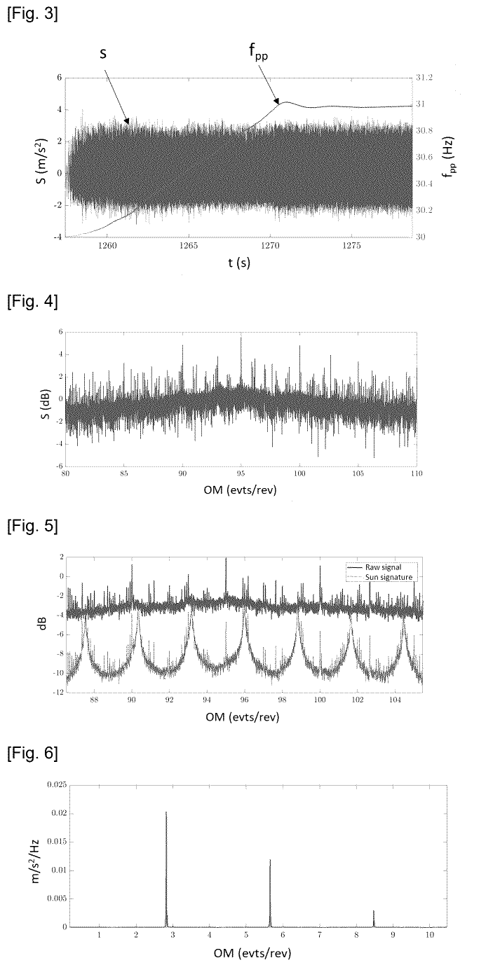

FIG. 3 shows an extract from the vibratory signal s acquired, as well as the rotation frequency fₚₚ of planet carrier 12, expressed as a function of time t.

In FIG. 4 the spectrum S of the vibratory signal s is represented as a function of the machine orders OM the reference of which is herein planet carrier 12.

Method 100 makes it possible to extract the signature of the damage to the sun gear 14 from the vibratory signal without taking account of the modulation induced by the planet carrier 12. For illustration purposes, the number of harmonics in the signature of the sun gear 14 is set to M=3.

In FIG. 5 the spectrum of the raw signal as well as the sun gear signature determined from the estimation of the vector of parameters of the associated model are represented. In FIG. 6 the spectrum of the sun gear signature 14 is represented without taking account of the effect of modulation by the planet carrier 12. The prominence of peaks related to the order of the sun gear fault, which is 2.8235, and its harmonics, are clearly distinguishable therein. However, this estimate does not take account of the effect of the modulation generated by planet carrier 12.

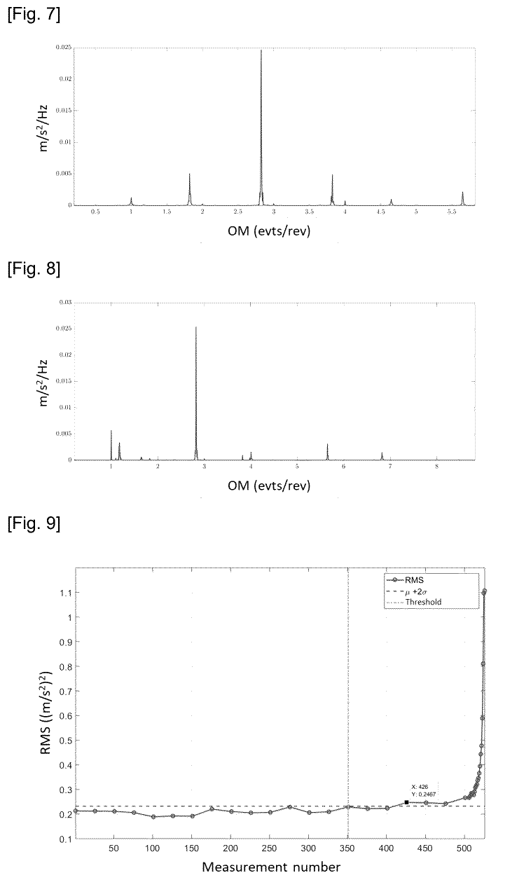

In FIG. 7 the spectrum of the estimated signature of sun gear 14 is represented with the effect of meshing and the effect of modulation of harmonic 1 of planet carrier 12. In FIG. 8 the spectrum of the signature is represented with taking account of the effect of the modulation of the planet carrier 12 when the first harmonic of the frequency of the sun gear 14 is considered, and when the latter is modulated by the harmonic 4 of the planet carrier 12.

It can therefore be observed that taking account of the interaction between the frequencies of the signature and those of the planet carrier 12 makes it possible to better explain peaks in the spectrum and as well as better reflect the actual state of the gear teeth of power transmission by a planetary gearset 10.

In the second example, method 100 is applied to vibratory data on damage to the planetary gearset 10 with propagation of the damage.

During the test, a crack has been detected in the gear root of a planet gear 13, which then spread across the entire width of the gear body.

To apply method 100, the following parameters are selected: k=1, M=4, Q=0, r=10, C=10⁻⁶×I, I being the identity matrix with an appropriate size.

Initialisations for the Kalman filter are made by random draw according to a Gaussian distribution.

The possible fault indicator is herein the Root-Mean-Square (RMS) value applied to the fault signature whose fundamental frequency is that of the planet gear 13 fault. The course of the possible fault indicator is displayed in FIG. 9. The threshold is herein set, for illustrative purposes, to twice the standard deviation (indicated by the notation μ+2σ where μ is the mean value of the indicator and σ is the standard deviation) of the same indicator in the absence of damage to the gear, which is the case before the 350th measurement. It is possible to observe a sharp increase in the RMS value, reflecting the propagation of the damage throughout the body of the gear, as has been observed during the test.

1. A method for monitoring the state of health of a planetary gearset equipping a rotating machine and adapted to perform power transmission on a shaft line of said rotating machine, the method comprising:
acquiring a vibratory signal of the rotating machine by a vibration sensor, the vibratory signal including vibrations generated during power transmission by the planetary gearset;
constructing a measurement vector and a transition matrix from a phenomenological vibratory model, said phenomenological vibratory model being based on a Fourier series decomposition of the vibratory signal taking account of interactions of different vibratory sources of the planetary gearset;
estimating a possible fault vibratory signature from the measurement vector, the transition matrix and the vibratory signal acquired, the possible fault vibratory signature taking account of a modulation overlap effect;
determining a distance by comparing the possible fault vibratory signature with a reference signature.

2. The method according to claim 1, wherein the vibratory signal is acquired during an acquisition duration, the acquisition duration being at least as long as a duration corresponding to a predetermined number of rotation cycles of a shaft of the rotating machine connected to the planetary gearset.

3. The method according to claim 2, wherein, in the acquiring, a speed of rotation of the shaft of the rotating machine connected to the planetary gearset is also measured.

4. The method according to claim 2, wherein the measurement vector is constructed from kinematics data of the planetary gearset and of the shaft to which the planetary gearset is connected and from parameters of the phenomenological vibratory model.

5. The method according to claim 1, wherein the transition matrix is an identity matrix whose size depends on the parameters of the phenomenological vibratory model.

6. The method according to claim 1, wherein the estimating the possible fault vibratory signature comprises the following two sub-steps of:
recursively estimating an estimated vector of the parameters of the model of the signal acquired, the estimation being a recursive estimation performed by means of a Kalman filter, the Kalman filter taking as an input the vibratory signal acquired, the transition matrix and the measurement vector;
reconstructing the possible fault vibratory signature from the estimated vector of the parameters of the model of the signal acquired.

7. The method according to claim 1, wherein the distance is a difference between a standard deviation of a possible fault indicator calculated for the possible fault vibratory signature and a standard deviation of the possible fault indicator calculated for the reference signature.

8. A device for monitoring the state of health of a planetary gearset for the implementation of the method according to claim 1, the device comprising:
an acquisition module comprising at least one vibration sensor and configured to implement the acquisition step of the method;
a processing module configured to implement the steps of constructing a measurement vector and a transition matrix, estimating a possible fault vibratory signature, determining a distance and issuing an alert.

9. A computer program product comprising instructions which, when the program is executed on a computer, cause the same to implement the steps of the method according to claim 1.

10. A non-transitory computer-readable recording medium comprising instructions which, when executed by a computer, cause the same to implement the steps of the method according to claim 1.
